(19) United States
(12) Patent Application Publication
(10) Pub. No.: US 2022/0004068 A1
(43) Pub. Date: Jan. 6, 2022

(54) LIQUID CRYSTAL DISPLAY CIRCUIT, LIQUID CRYSTAL DISPLAY DRIVING METHOD, AND DISPLAY PANEL

(71) Applicant: TCL China Star Optoelectronics Technology Co., Ltd, Shenzhen (CN)

(72) Inventor: Hongyuan XU, Shenzhen (CN)

(73) Assignee: TCL China Star Optoelectronics Technology Co., Ltd, Shenzhen (CN)

(21) Appl. No.: 16/620,878

(22) PCT Filed: Nov. 13, 2019
(86) PCT No.: PCT/CN2019/118186

§ 371 Date: Dec. 10, 2019

(30) Foreign Application Priority Data
Oct. 12, 2019 (CN) 201910966833.6

(51) Int. Cl. G02F 1/1362; G02F 1/1368; G09G 3/36

(52) U.S. Cl. CPC G02F 1/136286; G02F 1/1368; G09G 3/3614; G09G 2320/028; G09G 2310/08; G09G 2320/0242; G09G 3/3607

(57) ABSTRACT

A liquid crystal circuit of the present disclosure includes a plurality of pixel units arranged in an array. Each of the pixel units includes a first pixel region and a second pixel region. A plurality of data lines are connected to pixel units in order to transmit data signals to the pixel units. Each of the data lines includes a first signal lines and a second signal lines. A plurality of scan lines are connected to the pixel units in order to transmit driving signals to the pixel units. A first clock signal line and a second clock signal line are alternately turned on or off so that voltage potentials of the first pixel region and the second pixel region are different.

### FIELD OF INVENTION

The present disclosure relates to a field of panel manufacturing technologies, more particularly to a liquid crystal display circuit, a liquid crystal display driving method, and a display panel.

### BACKGROUND OF INVENTION

Liquid crystal displays (LCDs) are a widely used panel display and implement image display by adjusting the intensity of a backlight source through liquid crystal switches.

LCDs have plurality of display modes. Vertical alignment (VA) mode is a display mode having advantages such as high display contrast, wide viewing angles, and does not require friction alignment, etc. The problems of color shift at large viewing angles worsen due to larger birefringence differences of the liquid crystal polymers because VA display adopts liquid crystals rotating vertically.

Therefore, technical problems are urgently required to be solved by a skilled person in the art to reduce color shift, thereby are solved.

### SUMMARY OF INVENTION

The present disclosure provides a liquid crystal display (LCD) circuit, a LCD circuit driving method, and a display panel to reduce color shift.

An embodiment of the present disclosure provides a LCD circuit including:

A plurality of pixel units arranged in an array, wherein each of the pixel units comprises a first pixel region and a second pixel region.

A plurality of data lines connected to the pixel units and configured to transmit data signals to the pixel units, wherein each of the data lines comprises a first signal line and a second signal line.

A plurality of scan lines connected to the pixel units and configured to transmit driving signals to the pixel units.

A first clock signal line connected to the first signal line.

A second clock signal line connected to the second signal line;

Wherein the first clock signal line is configured to control the first signal line, the second clock signal line is configured to control the second signal line. The first clock signal line and the second clock signal line are turned on alternately to render a voltage potential of the first pixel region different from a voltage potential of the second pixel region.

In some embodiments, the first signal line is provided with a first switch, the second signal line is provided with a second switch. The first clock signal line is connected to the first switch, and the second clock signal line is connected to the second switch.

In some embodiments, the first switch is configured to control the first signal line, the second switch is configured to control the second signal line. A polarity of the first signal line and a polarity of the second signal line are inversed.

In some embodiments, the first switch is a P-type switch and the second switch is an N-type switch.

In some embodiments, two adjacent ones of the pixel units arranged in a same row have inversed polarities.

In some embodiments, reset frequencies of the first clock signal line and the second clock signal line are 120 Hz.

In some embodiments, the first switch and the second switch are a same type of switch.

The present disclosure further provides a LCD circuit driving method comprising:

Providing a plurality of pixel units arranged in an array. Each of the pixel units comprises a first pixel region and a second pixel region.

Providing a plurality of data lines connected to the pixel units and configured to transmit data signals to the pixel units. Each of the data lines comprises a first signal line and a second signal line.

Providing a plurality of scan lines connected to the pixel units and configured to transmit driving signals to the pixel units.

Providing a first clock signal line, wherein the first clock signal line is connected to the first signal line.

Providing a second clock signal line, wherein the second clock signal line is connected to the second signal line.

Wherein the first clock signal line is configured to control the first signal line, the second clock signal line is configured to control the second signal line, and the first clock signal line and the second clock signal line are turned on alternately to render a voltage potential of the first pixel region different from a voltage potential of the second pixel region.

In some embodiments, the first signal line is provided with a first switch, the second signal line is provided with a second switch. The first clock signal line is connected to the first switch, and the second clock signal line is connected to the second switch.

In some embodiments, the first switch is configured to control the first signal line, the second switch is configured to control the second signal line. A polarity of the first signal line and a polarity of the second signal line are inversed.

In some embodiments, the first switch is a P-type switch and the second switch is an N-type switch.

In some embodiments, two adjacent ones of the pixel units arranged in a same row have inversed polarities.

In some embodiments, reset frequencies of the first clock signal line and the second clock signal line are 120 Hz.

In some embodiments, the first switch and the second switch are a same type of switch.

The present disclosure provides a display panel comprising a liquid crystal display (LCD) circuit, wherein the LCD circuit comprises a plurality of pixel units arranged in an array. Each of the pixel units comprises a first pixel region and a second pixel region.

A plurality of data lines connected to the pixel units and configured to transmit data signals to the pixel units, wherein each of the data lines comprises a first signal line and a second signal line.

A plurality of scan lines connected to the pixel units and configured to transmit driving signals to the pixel units.

A first clock signal line connected to the first signal line.

A second clock signal line connected to the second signal line.

Wherein the first clock signal line is configured to control the first signal line, the second clock signal line is configured to control the second signal line, and the first clock signal line and the second clock signal line are turned on alternately to render a voltage potential of the first pixel region different from a voltage potential of the second pixel region.

In some embodiments, the first signal line is provided with a first switch, the second signal line is provided with a second switch. The first clock signal line is connected to the first switch, and the second clock signal line is connected to the second switch.

In some embodiments, the first switch is configured to control the first signal line, the second switch is configured to control the second signal line. A polarity of the first signal line and a polarity of the second signal line are inversed.

In some embodiments, the first switch is a P-type switch and the second switch is an N-type switch.

In some embodiments, two adjacent ones of the pixel units arranged in a same row have inversed polarities.

In some embodiments, reset frequencies of the first clock signal line and the second clock signal line are 120 Hz.

In the embodiment of the present disclosure, the plurality of pixel units are arranged in an array. Each of the pixel units includes the first pixel region and the second pixel region. The plurality of data lines are connected to the pixel units in order to input data signals to the pixel units. Each of the data lines includes a first signal lines and the second signal lines. The plurality of scan lines are connected to the pixel units in order to transmit driving signals to the pixel units. The first clock signal line is connected to the first signal line. The second clock signal line is connected to the second signal line. The first clock signal lines are configured to control the first signal lines. The second clock signal lines are configured to control the second signal lines. The first clock signal line and the second clock signal line are alternately turned on or off so that voltage potentials of the first pixel region and the second pixel region are different. Because the LCD circuit of the present application divides the data lines into two signal lines. The two signal lines are alternately controlled by the two clock signal lines and respectively input different voltage potentials to the first pixel region and the second pixel region. Thus the low color shift effect is achieved.

### DESCRIPTION OF DRAWINGS

In order to clarify embodiments or technical solutions of the present technologies, the required drawings of the embodiments will be briefly described below.

FIG. 1 illustrates a structural diagram of a liquid crystal display circuit of an embodiment of the present disclosure.

FIG. 2 illustrates another structural diagram of the liquid crystal display circuit of the embodiment of the present disclosure.

FIG. 3 illustrates sequence diagram of the liquid crystal display circuit of the embodiment of the present disclosure.

### DETAILED DESCRIPTION OF PREFERRED EMBODIMENTS

The technical solutions of embodiments of the present disclosure are provided accompanying with drawings to clearly and entirely illustrate specific embodiments. Obviously, the mentioned embodiments are only parts of the embodiments instead of all of the embodiments. Other embodiments can be obtained by a skilled person in the art without creative effort fall in the protected scope of the present disclosure.

The present disclosure provides a liquid crystal display (LCD) circuit 100, a driving method of LCD circuit 100, and a display panel. The detail description of the LCD circuit 100 is as following.

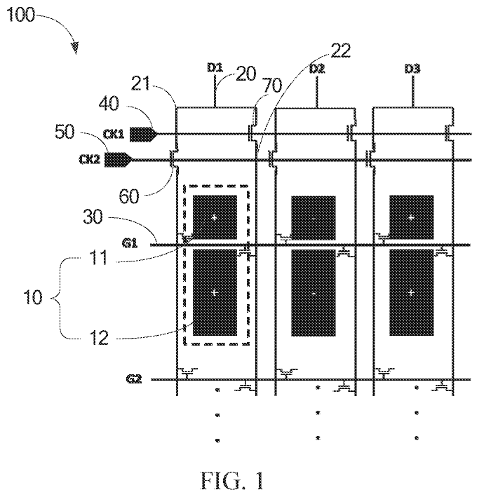

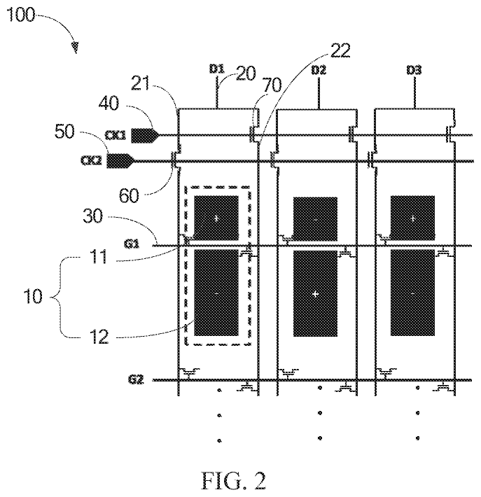

Please refer to FIG. 1 and FIG. 2. FIG. 1 provides a structural circuit diagram of the LCD circuit 100 of the embodiment of the present disclosure. FIG. 2 provides another structural circuit diagram of the LCD circuit 100 of the embodiment of the present disclosure. The LCD circuit 100 includes a plurality of pixel units 10, a plurality of data lines 20, a plurality of scan lines 30, a first clock signal line 40, and a second clock signal line 50. The plurality of pixel units 10 are arranged in an array. Each of the pixel units 10 includes a first pixel region 11 and a second pixel region 12. The plurality of data lines 20 are connected to first signal lines 21 and second signal lines 22 in order to input data signals to the pixel units 10. The plurality of scan lines 30 are connected to the pixel units in order to transmit driving signals to the pixel units 10. The first clock signal line 40 is connected to the first signal line 21. The second clock signal line 50 is connected to the second signal line 22. The first clock signal lines 40 are configured to control the first signal lines 21. The second clock signal lines 50 are configured to control the second signal lines 22. The first clock signal line 40 and the second clock signal line 50 are alternately turned on or off so that voltage potentials of the first pixel region 11 and the second pixel region 12 are different.

It should be noted that the second clock signal lines 50 turn on the data lines 20 in order to input a high voltage potential to the first pixel regions 11, and the first clock signal line 40 is turned on later thus a low voltage potential is inputted to the second pixel region 12 through the data lines 20. As a result, the first pixel region 11 and the second pixel region 12 are at different voltage potentials and the low color shift effect is achieved.

The first signal line 21 is provided with a first switch 60. The second signal line 22 is provided with a second switch 70. The first clock signal line 40 is connected to the first switches 60. The second clock signal line 50 is connected to the second switches 70. By utilized this structure,

the first clock signal line 40 and the second clock signal line 50 can be alternately switched on or switched off, thus the low color shift effect is achieve.

The first switches 60 are configured to control the first signal lines 21, and the second switch 70 are configured to control the second signal lines 22. The first signal line 21 and the second signal line 22 have inversed polarities. This structure can avoid emissions of radio frequency.

The first switches 60 are P-type switches. The second switches 70 are N-type switches. Obviously, the first switch 60 and the second switch 70 can also adopt the same type of switch. The formed structural of the first switch 60 and the second switch 70 in the embodiment of the present application are specifically defined.

Two of the adjacent pixel units 10 disposed in the same column have inversed polarities.

In the embodiment of the present disclosure, the plurality of pixel units 10 are arranged in an array. Each of the pixel units 10 includes the first pixel region 11 and the second pixel region 12. The plurality of data lines 20 are connected to the first signal lines 21 and the second signal lines 22 in order to input data signals to the pixel units 10. The plurality of scan lines 30 are connected to the pixel units 10 in order to transmit driving signals to the pixel units 10. The first clock signal line 40 is connected to the first signal line 21. The second clock signal line 50 is connected to the second signal line 22. The first clock signal lines 40 are configured to control the first signal lines 21. The second clock signal lines 50 are configured to control the second signal lines 22. The first clock signal line 40 and the second clock signal line 50 are alternately turned on or off so that voltage potentials of the first pixel region 11 and the second pixel region 12 are different. Because the LCD circuit 100 of the present application divides the data lines 20 into two signal lines. The two signal lines are alternately controlled by the two clock signal lines and respectively input different voltage potentials to the first pixel region 11 and the second pixel region 12. Thus the low color shift effect is achieved.

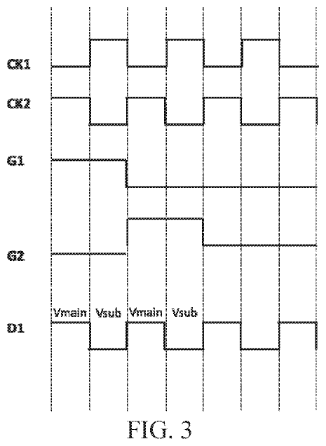

Please refer to FIG. 3 which illustrate sequence diagram of the LCD circuit of the embodiment of the present disclosure. The LCD circuit driving method comprises following steps.

Providing the plurality of pixel units arranged in an array. Each of the pixel units includes the first pixel region and the second pixel region.

Providing the plurality of data lines connected to the pixel units and configured to transmit the data signals to the pixel units. Each of the data lines includes the first signal line and the second signal line.

Providing the plurality of scan lines connected to the pixel units and configured to transmit the driving signals to the pixel units.

Providing the first clock signal line connected to the first signal line.

Providing a second clock signal line connected to the second signal line.

The first clock signal line is configured to control the first signal line. The second clock signal line is configured to control the second signal line. The first clock signal line and the second clock signal line are turned on alternately to render the voltage potential of the first pixel region different from the voltage potential of the second pixel region.

It should be noted that the second clock signal lines turn on the data lines in order to input the high voltage potential to the first pixel regions, and the first clock signal line is turned on later thus the low voltage potential is inputted to the second pixel region through the data lines. As a result, the first pixel region and the second pixel region are at different voltage potentials and the low color shift effect is achieved.

More particularly, the reset frequencies of the first clock signal line and the second clock signal line are 120 Hz while the resent voltage of the display panel is 60 Hz.

The first signal line is provided with a first switch. The second signal line is provided with a second switch. The first clock signal line is connected to the first switches. The second clock signal line is connected to the second switches. By utilized this structure, the first clock signal line and the second clock signal line can be alternately switched on or switched off, thus the low color shift effect is achieve.

The first switches are configured to control the first signal lines, and the second switches are configured to control the second signal lines. The first signal line and the second signal line have inversed polarities. This structure can avoid emissions of radio frequency.

The first switches are P-type switches. The second switches are N-type switches. Obviously, the first switch and the second switch can also adopt the same type of switch. The formed structural of the first switch and the second switch in the embodiment of the present application are specifically defined.

Two of the adjacent pixel units disposed in the same column have inversed polarities.

The embodiment of the present application further provides a display panel. The display panel includes the LCD circuit described above. Because the LCD circuit has been described in detail above thus will not repeat again.

The liquid crystal display circuit, the liquid crystal display circuit driving method and the display panel provided by the embodiments of the present application are described in detail above.

The aspects and embodiments of the present application are illustrates accompanying with the specific examples. The description of the above embodiments is only for the purpose of clarifying the present application. In the meanwhile, a skilled person in the art can change the specific embodiments and application scope according to the aspect of the present application. To conclude, the content of this specification should not limit the present disclosure.

What is claimed is:

1. A liquid crystal display (LCD) circuit, comprising:
a plurality of pixel units arranged in an array, wherein each of the pixel units comprises a first pixel region and a second pixel region;
a plurality of data lines connected to the pixel units and configured to transmit data signals to the pixel units, wherein each of the data lines comprises a first signal line and a second signal line;
a plurality of scan lines connected to the pixel units and configured to transmit driving signals to the pixel units;
a first clock signal line connected to the first signal line; and
a second clock signal line connected to the second signal line;
wherein the first clock signal line is configured to control the first signal line, the second clock signal line is configured to control the second signal line, and the first clock signal line and the second clock signal line are turned on alternately to render a voltage potential of the first pixel region different from a voltage potential of the second pixel region.

2. The LCD circuit according to claim 1, wherein the first signal line is provided with a first switch, the second signal line is provided with a second switch, the first clock signal line is connected to the first switch, and the second clock signal line is connected to the second switch.

3. The LCD circuit according to claim 2, wherein the first switch is configured to control the first signal line, the second switch is configured to control the second signal line, and a polarity of the first signal line and a polarity of the second signal line are inversed.

4. The LCD circuit according to claim 3, wherein the first switch is a P-type switch and the second switch is an N-type switch.

5. The LCD circuit according to claim 4, wherein two adjacent ones of the pixel units arranged in a same row have inversed polarities.

6. The LCD circuit according to claim 1, wherein reset frequencies of the first clock signal line and the second clock signal line are 120 Hz.

7. The LCD circuit according to claim 2, wherein the first switch and the second switch are a same type of switch.

8. A liquid crystal display (LCD) circuit driving method, comprising:
providing a plurality of pixel units arranged in an array, wherein each of the pixel units comprises a first pixel region and a second pixel region;
providing a plurality of data lines connected to the pixel units and configured to transmit data signals to the pixel units, wherein each of the data lines comprises a first signal line and a second signal line;
providing a plurality of scan lines connected to the pixel units and configured to transmit driving signals to the pixel units;
providing a first clock signal line, wherein the first clock signal line is connected to the first signal line; and
providing a second clock signal line, wherein the second clock signal line is connected to the second signal line;
wherein the first clock signal line is configured to control the first signal line, the second clock signal line is configured to control the second signal line, and the first clock signal line and the second clock signal line are turned on alternately to render a voltage potential of the first pixel region different from a voltage potential of the second pixel region.

9. The LCD circuit driving method according to claim 8, wherein the first signal line is provided with a first switch, the second signal line is provided with a second switch, the first clock signal line is connected to the first switch, and the second clock signal line is connected to the second switch.

10. The LCD circuit driving method according to claim 9, wherein the first switch is configured to control the first signal line, the second switch is configured to control the second signal line, and a polarity of the first signal line and a polarity of the second signal line are inversed.

11. The LCD circuit driving method according to claim 10, wherein the first switch is a P-type switch and the second switch is an N-type switch.

12. The LCD circuit driving method according to claim 11, wherein two adjacent ones of the pixel units arranged in a same row have inversed polarities.

13. The LCD circuit driving method according to claim 8, wherein reset frequencies of the first clock signal line and the second clock signal line are 120 Hz.

14. The LCD circuit driving method according to claim 9, wherein the first switch and the second switch are a same type of switch.

15. A display panel comprising a liquid crystal display (LCD) circuit, wherein the LCD circuit comprises:
a plurality of pixel units arranged in an array, wherein each of the pixel units comprises a first pixel region and a second pixel region;
a plurality of data lines connected to the pixel units and configured to transmit data signals to the pixel units, wherein each of the data lines comprises a first signal line and a second signal line;
a plurality of scan lines connected to the pixel units and configured to transmit driving signals to the pixel units;
a first clock signal line connected to the first signal line; and
a second clock signal line connected to the second signal line;
wherein the first clock signal line is configured to control the first signal line, the second clock signal line is configured to control the second signal line, and the first clock signal line and the second clock signal line are turned on alternately to render a voltage potential of the first pixel region different from a voltage potential of the second pixel region.

16. The LCD circuit according to claim 15, wherein the first signal line is provided with a first switch, the second signal line is provided with a second switch, the first clock signal line is connected to the first switch, and the second clock signal line is connected to the second switch.

17. The LCD circuit according to claim 16, wherein the first switch is configured to control the first signal line, the second switch is configured to control the second signal line, and a polarity of the first signal line and a polarity of the second signal line are inversed.

18. The LCD circuit according to claim 16, wherein the first switch is a P-type switch and the second switch is an N-type switch.

19. The LCD circuit according to claim 15, wherein two adjacent ones of the pixel units arranged in a same row have inversed polarities.

20. The LCD circuit according to claim 16, wherein reset frequencies of the first clock signal line and the second clock signal line are 120 Hz.
